(19) United States
(12) Patent Application Publication
(10) Pub. No.: US 2010/0214970 A1
(43) Pub. Date: Aug. 26, 2010

(54) METHOD AND SYSTEM FOR TRANSMITTING DATA PACKETS FROM A SOURCE TO MULTIPLE RECEIVERS VIA A NETWORK

(75) Inventors: Marcus Brunner, Leimen (DE); Henrik Lundqvist, Heidelberg (DE)

Correspondence Address: YOUNG & THOMPSON, 209 Madison Street, Suite 500, Alexandria, VA, 22314, US

(73) Assignee: NEC EUROPE LTD, Heidelberg (DE)

(21) Appl. No.: 12/680,623

(22) PCT Filed: Sep. 29, 2008
(86) PCT No.: PCT/EP08/08268

§ 371 Date: Mar. 29, 2010

(30) Foreign Application Priority Data
Sep. 28, 2007 (EP) 07019128.3

(51) Int. Cl. H04H 20/71

(52) U.S. Cl. 370/312

(57) ABSTRACT

A method for transmitting data packets from a source to multiple receivers via a network is characterized in that a network element (5) is provided between the source (2) and the multiple receivers (3a, 3b) such that the transmitted data packets transit the network element (5), wherein data packet losses experienced by the multiple receivers (3a, 3b) are reported to the network element (5), and wherein the reported lost data packets are encoded and retransmitted by the network element (5). Furthermore, a respective system is disclosed.

The present invention relates to a method and a system for transmitting data packets from a source to multiple receivers via a network.

Transmission of data packets from a source to multiple receivers forming a multicast tree is of steadily growing importance, in particular with respect to multimedia content distribution. In multimedia distribution networks, losing data packets can have a negative impact on the Quality of Experience (QoE) of users consuming the multimedia content. It is known that, depending on the coding of multimedia streams, packet loss can have a larger or smaller impact on the quality of the content.

For many applications the assumption is justified that the multimedia content is not immediately played out at the receiver side. Although multimedia content includes real-time data and data thus must be received within a bounded amount of time, there is a short period of time for which the data packets are typically buffered at the receiver, before the buffer is used to play-out or display the media. During this short period of time it makes sense to address missing packets and to try to get them recovered.

For packet losses that occur on the common part of a multicast tree retransmission is relatively efficient, since all hosts are missing the same packets. However, for losses that occur on links that are unique to each host it is less efficient to retransmit packets, since different hosts will typically lose different packets. For example, with an optical access network losses are unlikely, but on home networks that may use wireless links and possibly no prioritisation of different classes of traffic, or wide-area wireless networks, like UMTS or LTE, losses are more likely.

Reliability of multicast delivery is important not only for traditional file transfers, but particularly for providing high quality of experience for IPTV. The current commercial interest in IPTV has caused a real new interest in IP multicast.

However, as described above, making multicast robust against packet losses in an efficient and scalable way is difficult since there are typically many users that may have lost packets with heterogeneous loss and delay characteristics among the users being involved.

There are some solutions that address the problem of packet losses in multicast. However, the approaches known in prior art prove to be disadvantageous in various aspects. For example, it is known to provide a video error repair function which is located in a router (as described e.g. in Cisco whitepaper, “Delivering Video Quality in Your IPTV Development”, URL: http://www.cisco.com/en/US/netsol/ns610/networking_solutions_white_paper0900aecd8057f290.shtml). The proposed error repair function, however, requires a relatively large bandwidth and is thus rather inefficient.

According to another approach, for some multicast systems, such as MBMS (as described in 3GPP, “TS 26.346, Multimedia Broadcast/Multicast Service (MBMS); Protocols and codecs (Release 7)”, URL: http://www.3gpp.org/ftp/Specs/html-info/26346.htm), powerful FEC (Forward Error Correction) coding is used to improve reliability. Unfortunately, this solution causes large delay, which renders the approach not suitable for real-time or quasi real-time applications.

In general, it can be stated that in systems with nodes having a large number of clients served through some sort of multicast (including IP multicast and application multicast), the storage as well as the additional transmission bandwidth for resending packets are a problem.

It is therefore an object of the present invention to improve and further develop a method and a system of the initially described type in such a way that, by employing mechanisms that are readily to implement, an improvement in terms of reliability and robustness against packet losses is achieved in a bandwidth efficient way.

In accordance with the invention, the aforementioned object is accomplished by a method comprising the features of claim 1. According to this claim such a method is characterized in that a network element is provided between said source and said multiple receivers such that said transmitted data packets transit said network element, wherein data packet losses experienced by said multiple receivers are reported to said network element, and wherein said reported lost data packets are encoded and retransmitted as a repair packet by said network element.

Furthermore, the aforementioned object is accomplished by a system comprising the features of independent claim 21. According to this claim, such a system is characterized in that it includes a network element, which is provided between said source and said multiple receivers such that said transmitted data packets transit said network element, wherein said network element is configured, upon reception of reports from said multiple receivers regarding data packet losses experienced by said multiple receivers, to encode said reported lost data packets into a repair packet and to retransmit said repair packet to said multiple receivers.

According to the invention it has first been recognized that in many applications the delay tolerance is too short to send back a message to the source of the data. Furthermore, it has been recognized that sending reports about all lost packets to the source does not scale for large multicast groups and that an end-to-end retransmission scheme would lead to feedback implosion when the receivers individually notify the source about what packets they need to get retransmissioned. The present invention proposes the insertion of a network element, which is located between the source and the multiple receivers on the common part of the multicast tree. Consequently, receivers do not have to report packet losses to the source, but can send their reports to the network element only, so that a loss recovery with low delay that scales for large multicast groups is realized. According to the invention the inserted network element is configured to encode data packets that have been reported as being lost and into a repair packet and to retransmit the repair packet to the multiple receivers. Using network coding drastically reduces the bandwidth required for retransmissions.

By reducing the additional transmission bandwidth for resending packets and by reducing the time needed for recovery of data packets, significant improvement of quality of experience of e.g. IPTV is achieved. It has to be noted that the present invention is applicable to multicast in both fixed and wireless networks.

The invention is particularly advantageous, if the network technology already supports multicast or broadcast like GPON (Gigabit Passive Optical Network) and radio, where there finally is really only sent one packet to let more than one client improve the QoE. The buffering of packets might already happen on the network nodes, for fast starts of a joining client.

According to a preferred embodiment the network element keeps a track of the packets reported as being lost. In particular, it may be provided that the network element buffers those data packets for a certain amount of time.

Advantageously, a retransmission period is defined at which repair packets are sent by the network element. With respect to a proper adaptation to the respective application it may be provided that the length of the retransmission period is chosen depending on the specific delay tolerance for receiving the repair packets at the multiple receivers.

According to an advantageous embodiment it may be provided that the network elements send a repair packet at the end of each retransmission period including all packets that have been reported to the network element as being lost during the retransmission period.

In view of a particularly efficient retransmission of repair packets, it may be provided that the network element keeps track of the maximum number of packets that any of the multiple receivers is missing. In such case, the network element can start encoding a new repair packet with the last requested packet (i.e. the second lost packet reported by a specific receiver) as first data packet to be included. Every time the encoding of a new repair packet is initialized, a timer may be started and, when a retransmission period has past, the repair packet may be sent unless it has already been sent due to dual requests from a single receiver.

According to another embodiment, a fixed time interval may be defined, wherein at the end of each such time interval, the network element sends as many repair packets as the highest number of packets requested by any of the multiple receivers. To ensure that application requirements are met, the length of the fixed time interval may be set smaller than the length of the retransmission period. In case of defining a time interval of fixed length an encoding that can generate multiple independent repair packets from the same set of data packets may be used. Alternatively, a simple encoding by means of XOR operations may be employed. In the latter case the packets to be encoded have to be distributed over different sets such that no set contains more than a single packet that is requested from any single receiver. Then one repair packet is generated from each of the sets.

According to a still further preferred embodiment, a maximum number of repair packets sent by the network element during a predefined time interval may be defined. Such specification may be realized by either defining the time interval or by defining the number of repair packets. By this means, an operator will be enabled to determine how reliable the service should be. A high number of repair packets increases the complexity but, on the other hand, reduces the probability of non-recoverable losses.

In particular, in cases more than a single repair packet shall be generated for an interval, encoding that can generate multiple independent repair packets may be employed. As what regards the behaviour of the network element in such cases, it may be provided that the network element continuously encodes all arriving packets into separate repair packets. As a consequence, no original data packets received from the source have to be buffered at the network element. Alternatively it may be provided that only the packets requested by the receivers are input into the repair packet. In this case a certain delay will be required before encoding is preformed, since the feedback from the receivers about lost packets needs to arrive first. Therefore, some packets need to be buffered by the network element before the encoding can start. However, the advantage of such embodiment is that the decoding can have lower complexity when fewer packets have been encoded.

As already mentioned above, the network coding employed by the network element may include a simple bitwise XOR operation. However, it is also possible to use more general network codes, for example binary (XOR-based) codes that can generate multiple independent parity packets from the same data packets (as described in M. Xiao, M. Médard, and T. Aulin, “A Binary Coding Approach for Combination Networks and General Erasure Networks,” In Proc. IEEE International Symposium on Information Theory (ISIT2007), URL: http://www.ce.chalmers.se/˜mxiao/NC_isit_{—}2007.pdf). Moreover, codes that combine the packets linearly with coefficients taken from larger Galois fields, or Reed-Solomon codes may be applied.

In terms of a specific application the transmitted data packets may constitute a multimedia stream, in particular an IPTV stream. The multimedia stream may be originated by a service provider, in particular an IPTV server, acting as source. In such case the multiple receivers may be subscribers to a multimedia service offered by that service provider. Advantageously, it may be provided that the network element starts sending repair packets when a predefined number of receivers has joined the multimedia stream. Such implementation allows for dynamic changing of what streams are supported by retransmissions and which ones not. This decision may also depend on the type of coding and the round trip time to the clients.

In case a packet has been lost upstream it may be recovered by a retransmission request from the network element to the source in case this is supported. It could for example be supported by using the same type of network coded retransmission from the source, thus creating a hierarchical repair system. Otherwise the network element will have to leave out the missing packet. The receivers will then request the missing packet, but as the network element sends out repair packets not containing the requested packet they can conclude that it is not available. Hence they will not keep requesting it. Alternatively the requests will stop as soon as the available time limit is exceeded so that the packet is no longer useful.

With respect to efficient feedback information from the receivers to the network element, RTCP (Real Time Control Protocol) receiver reports may be used, possibly following the extended profile as described in J. Ott et al., “Extended RTP Profile for Real-time Transport Control Protocol (RTCP)-Based Feedback (RTP/AVPF)”, RFC 4585, July, 2006. Another example particularly suitable for radio channels is to use a MAC layer ‘binary or’ channel where a joint channel is used for negative acknowledgements. The acknowledgement channel could be arranged so that the NACK for a specific packet is sent in a predetermined time slot. Each receiver may send a negative acknowledgement in case the corresponding packet has been lost and the network element can determine whether any of the receivers have sent a NACK and hence decide if the packet should be retransmitted.

In this context it is to be noted that the network element can be configured to fulfill application requirements on delay and reliability. This also determines the complexity in terms of processing and storage requirements. The maximum time that the network element needs to be able to retransmit a packet, and therefore has to buffer it, depends on the delay tolerance of the application and the time it takes to get feedback from the receivers. The feedback time depends on the feedback protocol used. For example, RTCP receiver reports incur larger delay than link layer NACKs. From these factors a maximum retransmission period can be determined, after that time the packets can be discarded from the buffer.

The network element might be a fixed line access network element such as (DSLAM, MSAN, . . . ) wireless access point (e.g. 3gpp NodeB, LTE NodeB).

There are several ways how to design and further develop the teaching of the present invention in an advantageous way. To this end, it is to be referred to the patent claim subordinate to patents claims 1 and 21 on the one hand, and to the following explanation of a preferred example of an embodiment of the invention illustrated by the drawing on the other hand. In connection with the explanation of the preferred example of an embodiment of the invention by the aid of the drawing, generally preferred embodiments and further developments of the teaching will be explained. In the drawing

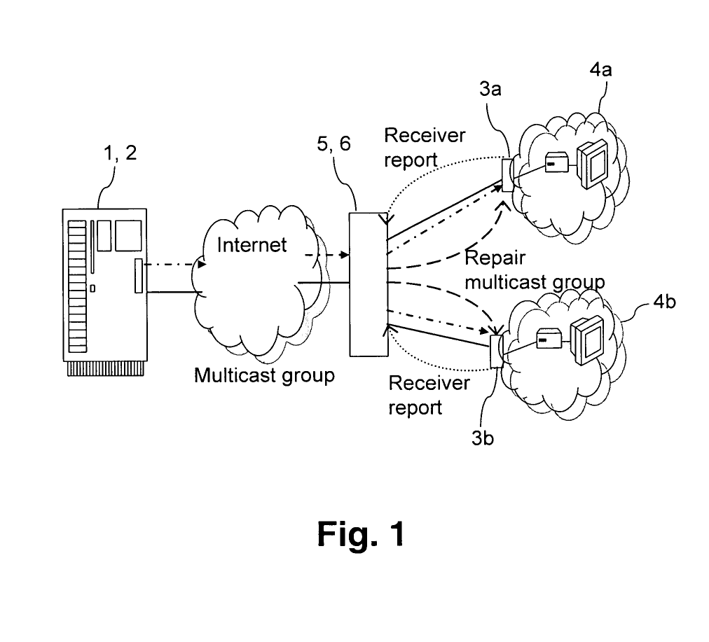

FIG. 1 illustrates an embodiment of the present invention related to an IP-TV application scenario,

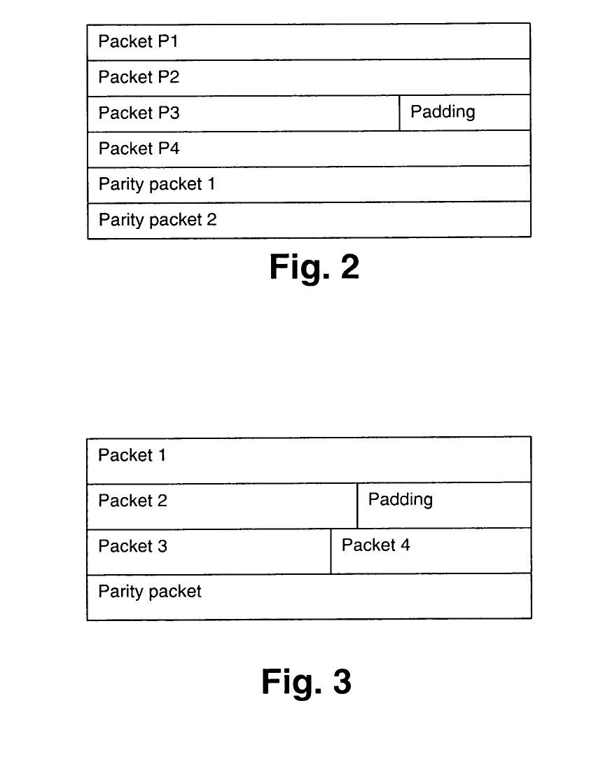

FIG. 2 illustrates a first example of encoding packets employed in a method according to the present invention, and

FIG. 3 illustrates another example of encoding packets employed in a method according to the present invention.

FIG. 1 illustrates an embodiment of a system according to the present invention in case of IP-TV multimedia streams. An IP-TV server 1 serves as a source 2 for the multimedia stream. The multimedia stream is transmitted as a multicast group via the internet to a multitude of hosts. The hosts may be subscribers to a multimedia service offered by the IP-TV server 1. For the purpose of simplicity, only two hosts from the multitude of hosts are illustrated in FIG. 1. Each of the two hosts is indicated by a receiver 3a, 3b that receives data packets, which are then processed by the respective application within the associated home networks 4a, 4b.

According to the invention a network element 5, which is a retransmission proxy 6, is inserted on the common part of the multicast tree between source 2 and the single receivers 3a, 3b. Although not specifically shown in FIG. 1, the retransmission proxy 6 can be located in a specific multi-service access node (GPON/MSAN), or in a wireless base station. To ensure that the data packets of the multimedia stream transit the proxy 6, a location on e.g. an edge router would also be beneficial.

In the example illustrated in FIG. 1, the retransmission proxy 6 defines the end of the common part of the multicast tree. However it is to be understood, that the retransmission proxy 6 can be located closer to the source 2 of the multimedia stream. Notwithstanding, best performance results in terms of low delays can be achieved with the proxy 6 being located on the common part of the multicast tree as close as possible to the receivers 3a, 3b.

In FIG. 1 the transmission of data packets of the multimedia stream from source 2 to receivers 3a, 3b is indicated by chain dotted line arrows. In case the receivers 3a, 3b realize that a data packet is missing in the received stream, they inform the retransmission proxy 6 accordingly by sending respective reports. These reports are indicated by dotted line arrows.

In the illustrated example multiple hosts report that they are missing different packets and the proxy 6 that handles retransmissions takes all of the packets being reported as missed/lost from its buffer and codes them into a single packet. The encoded packet is then transmitted to the receivers 3a, 3b as repair packet. For coding together missing packets into a minimal set of recovery packets, proxy 6 can use simple operations, possibly only XOR-operations. Each receiver 3a, 3b, upon receiving of a repair packet, can decode the packet to find exactly the packets it is missing. It is to be noted that the buffering and encoding in the retransmission proxy 6 can be adaptively adjusted due to the simple coding operations.

The method according to the invention can also be used in combination with end-to-end FEC (Forward Error Correction). In this case the receivers 3a, 3b do not have to request a retransmission as soon as a loss is detected since it may be recovered with the FEC parity packet from the source 2. In case more losses occur in the downstream network, so that some receivers 3a, 3b cannot decode the message FEC code word, the invention would work as described above. Hence, the lost packets could be recovered by the receivers 3a, 3b as long as the proxy 6 receives a sufficient number of packets to decode the whole transmission. However, the proxy 6 does not need to decode, it will suffice to encode the packets together and the end receivers 3a, 3b will first decode the network coding from the proxy 6, then the FEC encoding from the source 2.

FIG. 2 illustrates a simple example of how encoding of lost packets and the generation of repair or parity packets can be performed. It is assumed that packets labelled as P1, P2, P3 and P4 are sent to hosts A, B and C. It is further assumed that host A loses packet P2, host B loses packet P3 and host C loses packet P4.

All hosts send reports to the proxy 6 about which packets they have lost. The proxy 6 encodes Pcoded=P2+P3+P4 (where “+” represents bitwise XOR) and sends Pcoded on a multicast address to all of the hosts with a header informing about which original packets are encoded in Pcoded.

After receiving Pcoded, host A fetches P3 and P4 from its' receive buffer and decodes by calculating Pcoded+P3+P4=P2 (again “+” is XOR, hence P3+P3=0, P4+P4=0). Host B and host C decode in an analogous way to get packets P3 and P4, respectively.

As can be further obtained from FIG. 1, before encoding the packets to be retransmitted in one or more parity packets, the packets will be padded to have the same length. Specifically, padding is added to packet P3 to obtain the same length as packets P1, P2, and P4.

Alternatively, in case some packets are much shorter than the longest packet they can be encoded as a common packet as illustrated in FIG. 3. This would have the advantage that a receiver missing both packet 3 and packet 4 would be able to recover both of them from a single parity packet

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. Method for transmitting data packets from a source to multiple receivers via a network,
characterized in that a network element 5 is provided between said source (2) and said multiple receivers (3a, 3b) such that said transmitted data packets transit said network element (5), wherein data packet losses experienced by said multiple receivers (3a, 3b) are reported to said network element (5), and wherein said reported lost data packets are encoded and retransmitted as a repair packet by said network element (5).

2. Method according to claim 1, wherein said network element (5) keeps track of the packets reported as being lost, in particular by buffering said packets.

3. Method according to claim 1, wherein a retransmission period is defined, at which said repair packets are sent by said network element (5).

4. Method according to claim 3, wherein the length of said retransmission period is defined depending on the specific delay tolerance for receiving said transmitted data packets at said multiple receivers (3a, 3b).

5. Method according to claim 3, wherein said network element (5) sends a repair packet at the end of each said retransmission period including all packets that have been reported to said network element (5) as being lost during said retransmission period.

6. Method according to claim 1, wherein said network element (5) keeps track of the maximum number of packets that any of said multiple receivers (3a, 3b) is missing.

7. Method according to claim 1, wherein said network element (5), as soon as one of said multiple receivers (3a, 3b) is missing more than a single packet, sends one encoded packet that includes information of all packets that have been reported to said network element (5) as being lost since the last repair packet sent.

8. Method according to claim 1, wherein a fixed time interval is defined, wherein at the end of each said time interval the network element (5) sends as many repair packets as the highest number of packets requested by any of said multiple receivers (3a, 3b).

9. Method according to claim 8, wherein the length of said fixed time interval is smaller than the length of said retransmission interval.

10. Method according to claim 1, wherein a maximum number of repair packets sent by said network element (5) during a predefined time interval is defined.

11. Method according to claim 1, wherein said network element (5) employs an encoding mechanism which allows the generation of multiple independent repair packets from the same set of data packets.

12. Method according to claim 1, wherein said network element (5) continuously encodes all arriving data packets into separate repair packets.

13. Method according to claim 1, wherein said network element (5) includes only the requested data packets into said repair packets.

14. Method according to claim 1, wherein the network coding employed by said network element (5) includes a bitwise XOR operation.

15. Method according to claim 1, wherein the network coding employed by said network element (5) includes binary codes and/or codes that combine the data packets linearly with coefficients taken from a Galois field and/or Reed-Solomon codes.

16. Method according to claim 1, wherein said transmitted data packets constitute a multimedia stream, in particular an IP-TV stream.

17. Method according to claim 16, wherein said network element (5) starts sending repair packets when a predefined number of receivers joint said stream.

18. Method according to claim 1, wherein packets that are lost upstream between said source and said network element (5) are recovered by means of a retransmission request from said network element (5) to said source (2).

19. Method according to claim 1, wherein the feedback information from said multiple receivers (3a, 3b) to said network element (5) is realized by means of RTCP (Real Time Control Protocol) receiver reports.

20. Method according to claim 1, wherein the feedback information from said multiple receivers (3a, 3b) to said network element (5) is realized by means of a MAC layer “binary or” channel.

21. System for transmitting data packets from a source to multiple receivers via a network,
characterized in that the system includes a network element (5), which is provided between said source (2) and said multiple receivers (3a, 3b) such that said transmitted data packets transit said network element (5), wherein said network element (5) is configured, upon reception of reports from said multiple receivers (3a, 3b) regarding data packet losses experienced by said multiple receivers (3a, 3b), to encode said reported lost data packets into a repair packet and to retransmit said repair packet to said multiple receivers (3a, 3b).

22. System according to claim 21, wherein said network element (5) is a retransmission proxy (6).

23. System according to claim 21, wherein said network element (5) is located in an edge router or in a multi-service access node (MSAN).

24. System according to claim 21, wherein said source (2) is a service provider, in particular an IPTV server (1).

25. System according to claim 21, wherein said multiple receivers (3a, 3b) are subscribers to a multimedia service offered by said service provider.
